(19) United States
(12) Patent Application Publication
(10) Pub. No.: US 2026/0295762 A1
(43) Pub. Date: Oct. 1, 2026

(54) Systems and Methods for Object Honing and Testing

(71) Applicant: Relativity Space, Inc., Long Beach, CA (US)

(72) Inventors: Kenneth Yu Wai Ng, Long Beach, CA (US); Jeffrey Rossin, Long Beach, CA (US); Van Earl Bishop Wright, Jr., Long Beach, CA (US)

(73) Assignee: Relativity Space, Inc., Long Beach, CA (US)

(21) Appl. No.: 19/632,053

(22) Filed: Mar. 27, 2026

Related U.S. Application Data
(60) Provisional application No. 63/780,097, filed on Mar. 28, 2025.

(51) Int. Cl. B24B 33/04; B24B 33/06; B33Y 10/00; B33Y 40/20; B33Y 80/00; F02K 9/00

(52) U.S. Cl. CPC B24B 33/04; B24B 33/06; B33Y 40/20; B33Y 80/00; F02K 9/00; B33Y 10/00

(57) ABSTRACT

Systems and methods for honing articles with irregular surface geometry. Systems and methods for honing articles while maintaining the original cross section geometry. Systems and methods for enabling NDE testing of rough surfaced AM articles through honing as described herein.

### CROSS-REFERENCES TO RELATED APPLICATIONS

The current application claims priority to U.S. Provisional Application No. 63/780,097, filed Mar. 28, 2025, the disclosure of which is incorporated herein by reference in its entireties.

### FIELD OF THE INVENTION

This disclosure generally refers to systems and methods for post-production honing and testing of articles, particularly for additively manufactured articles.

### BACKGROUND

Honing is a post-production process to smooth or clean the surface of a manufactured article. A surface may be honed using an abrasive element against the surface of article to sand off or shave down rough surface reliefs.

Additive manufacturing is a process by which an article is manufactured by adding one layer of material on top of another in a sequence that results in the article being built. This method of manufacturing is commonly referred to as three dimensional or 3-D printing and can be done with different materials, including plastic and metal. There are many different processes available for implementing 3-D printing of articles, including, among others, direct energy deposition, wire arc additive manufacturing, powder bed fusion, and cold spray.

### SUMMARY OF THE INVENTION

Systems and methods in accordance with some embodiments of the invention are directed to post-production honing and testing of articles, particularly for additively manufactured articles.

In some embodiments, the techniques described herein relate to a method of producing an article, the method comprising: creating a wall of the article, using a first additive manufacturing technique, defining an interior cavity and having a substantially uniform wall thickness and a nominally cylindrical geometry about a central longitudinal axis, wherein a cross-section of the wall taken perpendicular to the central longitudinal axis exhibits an elliptical profile; reducing the substantially uniform wall thickness using a honing technique, wherein the reduced wall thickness remains substantially uniform; creating a first portion of a cladding layer of the article, using a second additive manufacturing technique, covering a honed surface of the wall and having a substantially uniform first portion thickness and a nominally cylindrical geometry about the central longitudinal axis, wherein a cross-section of the first portion taken perpendicular to the central longitudinal axis exhibits an elliptical profile; reducing the substantially uniform first portion thickness using the honing technique, wherein the reduced first portion thickness remains substantially uniform; creating a second portion of the cladding layer of the article, using the second additive manufacturing technique, covering a honed surface of the first portion and having a substantially uniform second portion thickness and a nominally cylindrical geometry about the central longitudinal axis, wherein a cross-section of the second portion taken perpendicular to the central longitudinal axis exhibits an elliptical profile; reducing the substantially uniform second portion thickness, using the honing technique, along a first extent of the central longitudinal axis, wherein the reduced second portion thickness remains substantially uniform along the first extent, and such that the second portion includes a honed surface of the second portion along the first extent and an un-honed surface of the second portion along a second extent of the central longitudinal axis.

In some embodiments, the techniques described herein relate to a method, wherein the article is a rocket engine thrust chamber assembly.

In some embodiments, the techniques described herein relate to a method, wherein the first additive manufacturing technique is a powder bed fusion technique.

In some embodiments, the techniques described herein relate to a method, wherein the second additive manufacturing technique is a wire arc additive manufacturing technique.

In some embodiments, the techniques described herein relate to a method, wherein the honing technique comprises: applying an abrasive element to a surface of the article, wherein the abrasive element and the surface are at a honing distance, wherein the honing distance is substantially constant; and moving at least one of the abrasive element and the surface such that the abrasive element removes material from the surface, wherein moving at least one of the abrasive element and the surface maintains the substantially constant honing distance between the abrasive element and the surface.

In some embodiments, the techniques described herein relate to a method, wherein the honing technique comprises: applying an abrasive element to a surface of the article, wherein the abrasive element applies a honing force to the surface, wherein the honing force is substantially constant; and moving at least one of the abrasive element and the surface such that the abrasive element removes material from the surface, wherein moving at least one of the abrasive element and the surface maintains the substantially constant honing force applied by the abrasive element to the surface.

In some embodiments, the techniques described herein relate to a method, wherein the surface is on at least one of the wall, the first portion of the cladding layer, and the second portion of the cladding layer.

In some embodiments, the techniques described herein relate to a method, wherein the honing distance is maintained by a tension system.

In some embodiments, the techniques described herein relate to a method, wherein the force is maintained by a tension system.

In some embodiments, the techniques described herein relate to a method, further comprising moving a non-destructive evaluation sensor along at least one of a honed surface of the wall, the honed surface of the first portion of the cladding layer, and the honed surface of the second portion of the cladding layer.

In some embodiments, the techniques described herein relate to a method, wherein the non-destructive evaluation sensor is an ultrasonic sensor.

In some embodiments, the techniques described herein relate to a method, wherein the elliptical profile results from a manufacturing deviation from circular symmetry.

In some embodiments, the techniques described herein relate to a method of producing an article, the method comprising: creating a wall of the article, using a first additive manufacturing technique, defining an interior cavity and having a substantially uniform wall thickness and a nominally cylindrical geometry about a central longitudinal axis, wherein a cross-section of the wall taken perpendicular to the axis exhibits an elliptical profile; reducing the substantially uniform wall thickness using a honing technique, wherein the reduced wall thickness remains substantially uniform; creating a cladding layer of the article, using a second additive manufacturing technique, covering a honed surface of the wall and having a substantially uniform cladding layer thickness and a nominally cylindrical geometry about the central longitudinal axis, wherein a cross-section of the cladding layer taken perpendicular to the axis exhibits an elliptical profile; and reducing the substantially uniform cladding layer thickness using a honing technique, wherein the reduced cladding layer thickness remains substantially uniform.

In some embodiments, the techniques described herein relate to a method, wherein the creating the cladding layer of the article includes: creating a first portion of the cladding layer of the article; reducing a substantially uniform thickness of the first portion using a honing technique, wherein the reduced thickness of the first portion remains substantially uniform; creating a second portion of the cladding layer of the article.

In some embodiments, the techniques described herein relate to a method, wherein the reducing the substantially uniform cladding layer thickness includes: reducing the substantially uniform cladding layer thickness, using the honing technique, along a first extent of the central longitudinal axis, wherein the reduced cladding layer thickness remains substantially uniform along the first extent, and such that the cladding layer includes a honed surface of the cladding layer along the first extent and an un-honed surface of the cladding layer along a second extent of the central longitudinal axis.

In some embodiments, the techniques described herein relate to a method, wherein the article is a rocket engine thrust chamber assembly.

In some embodiments, the techniques described herein relate to a method, wherein the first additive manufacturing technique is a powder bed fusion technique.

In some embodiments, the techniques described herein relate to a method, wherein the second additive manufacturing technique is a wire arc additive manufacturing technique.

In some embodiments, the techniques described herein relate to an article comprising: a wall defining an interior cavity and having a substantially uniform wall thickness and a nominally cylindrical geometry about a central longitudinal axis, wherein a cross-section of the wall taken perpendicular to the axis exhibits an elliptical profile; a first interface between a honed surface of the wall and an added surface of a first portion of a cladding layer; the first portion of the cladding layer covering the honed surface of the wall and having a substantially uniform first portion thickness and a nominally cylindrical geometry about the central longitudinal axis, wherein a cross-section of the first portion taken perpendicular to the axis exhibits an elliptical profile; a second interface between a honed surface of the first portion and an added surface of a second portion of the cladding layer; the second portion of the cladding layer covering the honed surface of the first portion and having a plurality of second portion thicknesses and a nominally cylindrical geometry about the central longitudinal axis, wherein a cross-section of the second portion taken perpendicular to the axis exhibits an elliptical profile; a honed surface of the second portion of the cladding layer extending along a first extent of the central longitudinal axis and having a honed thickness of the plurality of second portion thicknesses; and an un-honed surface of the second portion of the cladding layer extending along a second extent of the central longitudinal axis and having an un-honed thickness of the plurality of second portion thicknesses.

In some embodiments, the techniques described herein relate to the article, wherein an article is a rocket engine thrust chamber assembly.

Additional embodiments and features are set forth in component in the description that follows, and in component will become apparent to those skilled in the art upon examination of the specification or may be learned by the practice of the disclosure. A further understanding of the nature and advantages of the present disclosure may be realized by reference to the remaining portions of the specification and the drawings, which forms a component of this disclosure.

### BRIEF DESCRIPTION OF THE DRAWINGS

The description will be more fully understood with reference to the following figures, which are presented as embodiments of the invention and should not be construed as a complete recitation of the scope of the invention, wherein:

FIGS. 1A to 1D schematically illustrate an article before and after a lathe honing process.

FIGS. 2A and 2B schematically illustrate a hollowed article before and after a honing process in accordance with an embodiment.

FIGS. 3A to 3C schematically illustrate the angle of rotation of the abrasive element.

FIGS. 4A and 4B schematically illustrate an article honed in accordance with an embodiment.

FIG. 5 schematically illustrates a honing system configuration.

FIGS. 6A to 6D illustrate an example of an article honed in accordance with an embodiment.

FIGS. 7A to 7D schematically illustrate ultrasonic non-destructive evaluation or examination (NDE) testing of a honed article.

FIG. 7E illustrates an example of NDE testing of a honed article.

FIGS. 8A and 8B illustrate an example of a honing system configuration.

### DETAILED DESCRIPTION OF THE INVENTION

It will be understood that the components of the embodiments, as generally described herein and illustrated in the appended figures, may be arranged and designed in a variety of different configurations. Thus, the following more detailed description of various embodiments, as represented in the figures, is not intended to limit the scope of the present disclosure but is merely representative of various embodiments. While various aspects of the embodiments are presented in drawings, the drawings are not necessarily drawn to scale unless specifically indicated.

The present invention may be embodied in other specific forms without departing from its spirit or essential characteristics. The described embodiments are to be considered in all respects only as illustrative and not restrictive.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages and similar language throughout this specification may, but do not necessarily, refer to the same embodiment.

Furthermore, the described features, advantages, and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

Reference throughout this specification to “one embodiment,” “an embodiment,” or similar language means that a particular feature, structure, or characteristic described in connection with the indicated embodiment is included in at least one embodiment. Thus, the phrases “in one embodiment,” “in an embodiment,” and similar language throughout this specification may but do not necessarily, all refer to the same embodiment.

Additive manufacturing (AM) is the process of creating an article by building one layer at a time. This process can be contrasted with conventional molding or casting techniques, in which components of an article are individually created via a premade mold and then assembled together to the final article geometry.

Although it has some benefits compared to conventional techniques, AM involves challenges in ensuring that the final article has adequate engineering properties. This is true regardless of the particular type of AM technique employed to build an article. AM techniques include, for example, binder jetting (BJT), cold spray additive manufacturing (CS), directed energy deposition (DED), wire arc additive manufacturing (WAAM) or wire directed energy deposition (Wire-DED), material extrusion, and powder bed fusion (PBF), and sheet lamination, including laminated object manufacturing (LOM) and ultrasonic additive manufacturing (UAM), among others. Each of these species of the additive manufacturing genus has different capabilities in terms of material limitations, overall article size attainable, individual feature size available, etc.

Articles manufactured through AM often have a bumpy finished surface comprising bumps and waviness as opposed to a smooth, even surface. The outer surface of AM articles may be bumpy due to spattering of material during the manufacturing process, or due to the inherent feedstock (powder/wire) and rastering strategy inherent in AM techniques. The various bumps that make up the bumpy surface can also represent a parasitic load, i.e., additional material weight that does not provide mechanical or structural support. Reduced parasitic load is critical in various applications including flight, speed tests, and space travel. Furthermore, a smooth outer surface improves the properties and characteristics of AM articles. For example, an article with one or more smooth outer surfaces improves its ability to receive additional layers. A smooth outer surface can also improve the ability to image test AM article materials during nondestructive examination (NDE). NDE of AM articles allows for improved quality control and satisfies industry standards and regulations. NDE is often practiced using image testing or ultrasonic testing. In ultrasonic testing (UT), sound is emitted into the article material and bounced back to the sensor. The received return signal can characterize material properties and defect content. With traditional AM articles, ultrasonic testing is difficult or even impossible due to the bumpy outer surface of the article. The ultrasonic sensor does not sit flush to the bumpy surface, a condition which increases extraneous sensor noise. The bumpy surface also scatters the emitted noise further resulting in extraneous sensor noise and inaccurate readings. As such, as-printed AM articles are ineligible for most NDE testing techniques. Even other NDE techniques such as eddy current testing (ET) that can operate despite the rough surface, may not be capable of detecting critically sized flaws due to increased noise due to the surface.

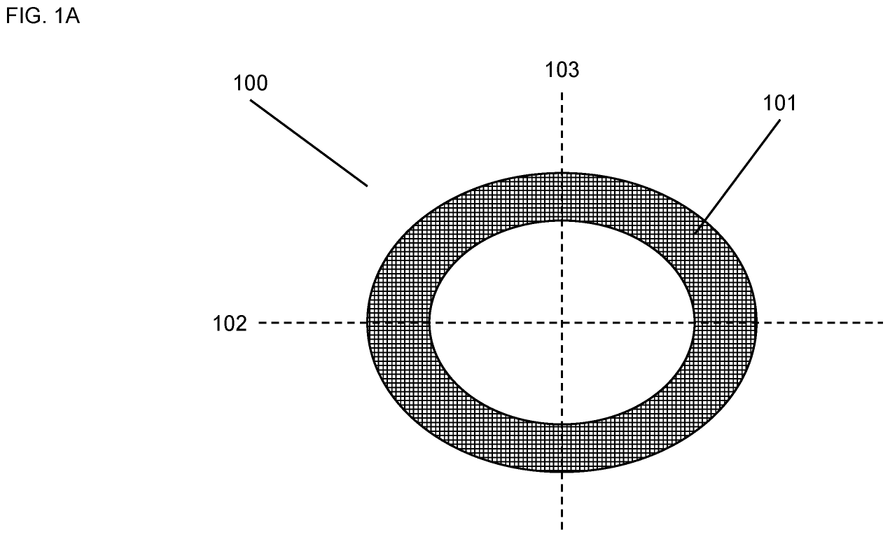

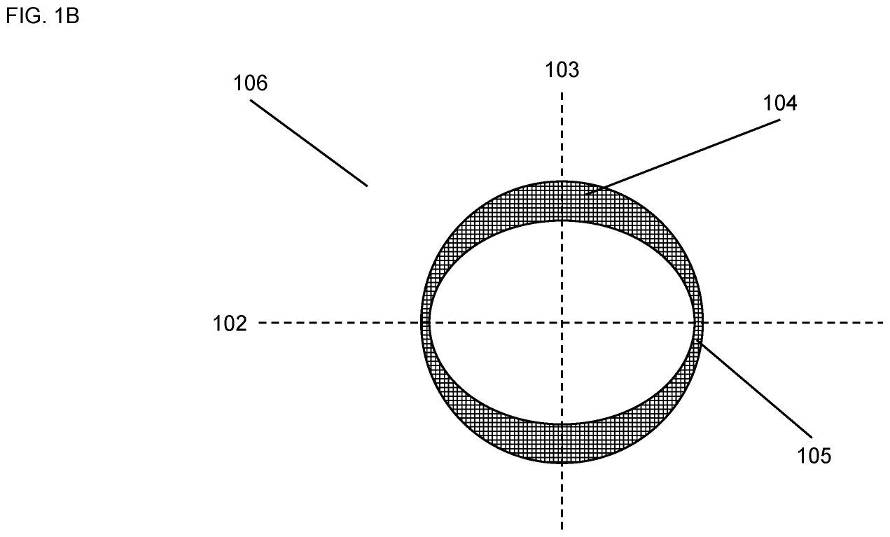

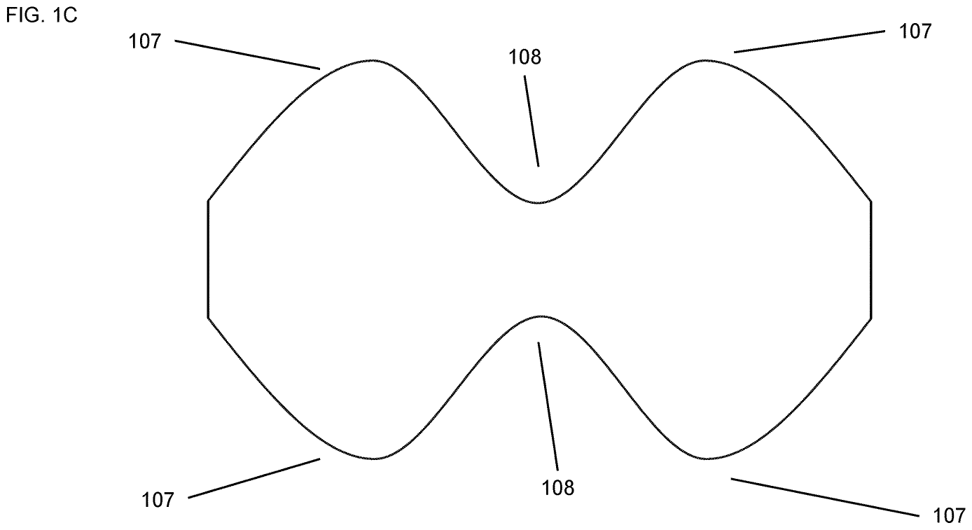

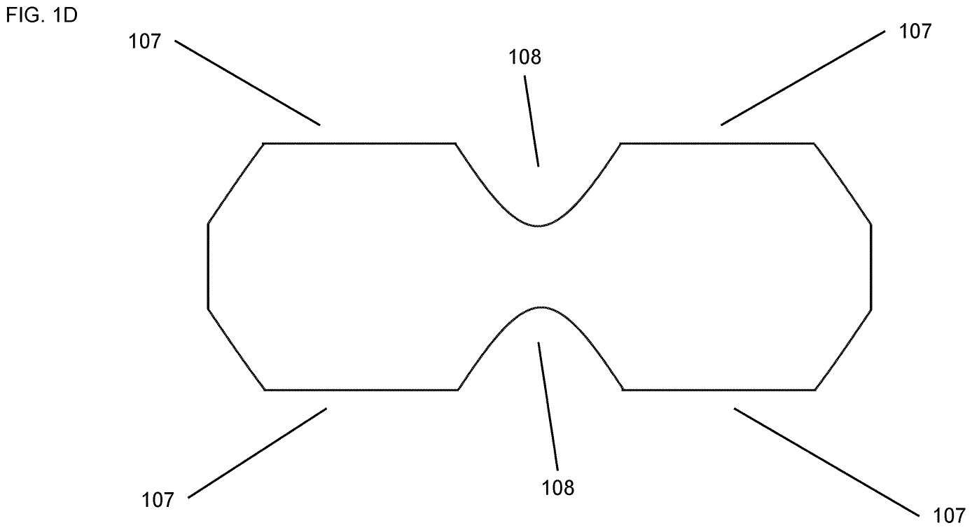

Traditional post-production machining techniques for axially symmetric (round) parts often utilize a lathe. A lathe can be used for post-production machining to hone the surface of an article using a cutting element such as a blade or an abrasive element such as sandpaper at a fixed distance from the central axis of the article. A lathe takes an indexing approach to post-production machining where the position of the cutting or abrasive honing element is referenced off the central axis. The article is rotated about an axis and the tool removes material from the surface of the article, such as by cutting or abrasion. Due to the indexed distance of the tool from the central axis of the article, lathe honing circularizes the exterior cross section of an article relative to the central axis location. Across the cross section of the article, some areas might have more material honed away based on their distance from the central axis to the honing element. FIGS. 1A and 1B depict an example of a lathe honed hollow article. FIG. 1A depicts the hollowed article prior to lathe honing. The thickness of the article wall 101 is equal at both the long axis 102 and short axis 103 of the elliptical cross section 100. The resulting article is honed from an elliptical exterior cross section to a circular exterior cross section through the unequal amount of material removed by the element. FIG. 1B depicts the resulting lathe honed hollow article. The lathe honed article now has a circular exterior cross section 106, although the interior cross section remains elliptical as shown. Furthermore, the thickness of the article walls in region 104 are thicker as compared to the walls in region 105 based on the uneven removal of material. In AM techniques, this is a particular problem when multiple layers are deposited. For example, an article may be lathe honed in between AM processes, such that the article is built by AM layers printed, honed, and AM layers printed again. In an article built by layered AM, the exterior surface may have uneven wall thickness due to the uneven mid-process lathe honing. The subsequent print layers may contribute to the unevenness by printing on an article with uneven wall thickness due to the lathe honing.

As such, many lathe based approaches to honing in the context of the present disclosure are inadequate for articles with complex surface contours, wherein the exterior cross section diameter varies along the length of the article. Lathe honing removes material based on a fixed distance from the central axis of the article, and thus fails to account for intended changes in the surface contour of the article. FIGS. 1C and 1D depict an example of a lathe honed article with complex surface contours. The article of FIGS. 1C and 1C have variable exterior cross section diameters, wherein the region 107 has a greater cross sectional diameter than the region 108. FIG. 1C depicts the initial article surface geometry comprising both concave regions 108 and convex regions 107. FIG. 1D depicts the lathe honed article surface geometry. The convex regions 107 have been modified, and the concave regions 108 have remained un-honed. If an article has a concave surface contour, a lathe will fail to hone the vertex of the concavity because the fixed distance from the central axis does not account for the concavity. Similarly, if the article has a convex surface contour, the lathe may remove some areas of convexity by honing the convex surface contour based on the fixed distance to the central axis of the article.

Aspects of this disclosure are directed towards systems and methods for honing articles without altering the geometry of the article cross section. Systems and methods for honing based on maintaining constant contact between the honing element and the exterior surface of the article are described herein. By maintaining constant contact with the exterior surface of the article, the honing element hones an approximately equal amount of material, whether by cutting, abrasion, or otherwise. Tension within the system to apply a honing force is maintained to provide constant contact between the element and the exterior surface of the article. The article honed in accordance with various embodiments, retains the original cross section because an equal amount of material is honed from every surface. In many embodiments, an article may have varied cross sections across the length of the article such that some regions of the exterior walls are closer to the central axis than others. The honing system of many embodiments may be configured to remove an equal amount of material from every region such that the honed article retains its original un-honed cross section variation. In many embodiments the honing system may be configured to maintain constant contact with the exterior surface of the article such that the distance between the central axis of the article and the abrasive element varies as the article is honed. In some embodiments, the variation in distance from the central axis of the article and the abrasive element may follow the variation in distance from the central axis of the article and the exterior article wall.

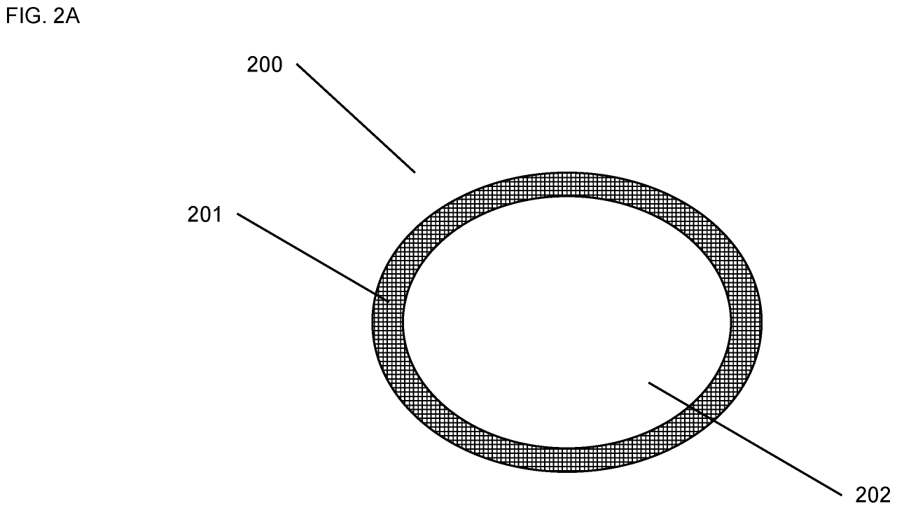

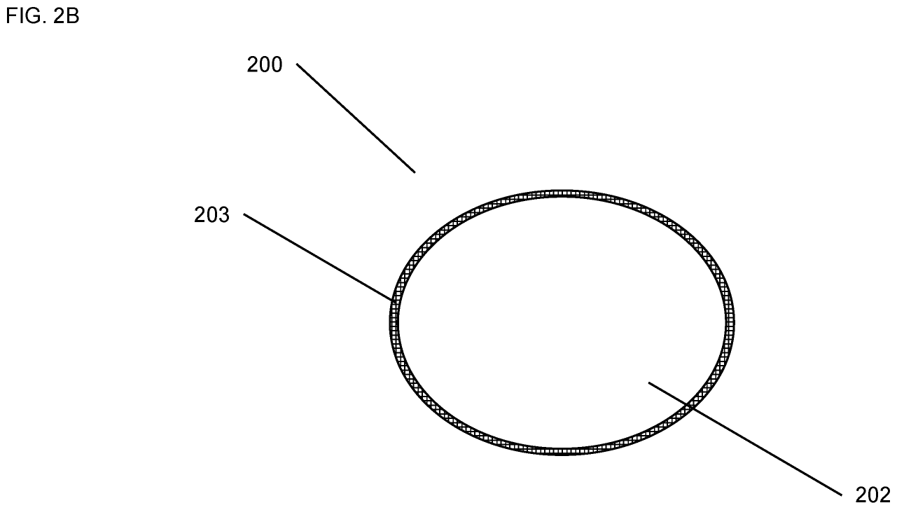

FIGS. 2A and 2B depict an article honed in accordance with an embodiment. FIG. 2A provides the cross section of a hollow article prior to honing and FIG. 2B provides the cross section of the article after honing in accordance with an embodiment. The honed article wall has maintained an equal thickness and has retained its original elliptical cross section. The article 200 can have a nominally cylindrical structure along a central longitudinal axis. The elliptical cross section perpendicular to the central longitudinal axis is shown in FIGS. 2A and 2B. In some embodiments, the elliptical cross section is caused by a manufacturing deviation from a circular symmetry. For example, the elliptical cross section can result from the impracticality of manufacturing a perfect circle. The article wall has a wall 201 defining an interior cavity 202. In FIG. 2A, the article wall 201 has a substantially uniform thickness. In FIG. 2B, the honed wall 203 has a substantially uniform thickness. The honed wall 203 has a smaller thickness than the article wall 201 because at least a portion of the wall 201 thickness is removed by honing techniques in accordance with an embodiment. The article honed in accordance with an embodiment maintains its elliptical cross section perpendicular to the central longitudinal axis. Though an article is described in FIGS. 2A and 2B, the honing techniques described herein can be applied to articles without deposited materials and articles with deposited materials, such as cladding layers.

Aspects of this disclosure are directed towards a honing system comprising an abrasive element and an article, although it should be understood that the aspects discussed below can also operate with other honing elements. The abrasive element is configured to contact the exterior surface of the article. The abrasive element is configured to remove thin layers of material from the article. In many embodiments, the abrasive element has a rough gritty surface to remove thin layers of material from the article. The grit, i.e., the roughness of the abrasive element, may be adjusted based on the material of the article. The grit may be adjusted based on the number of honing processes applied. An article that has undergone several iterative honing steps may utilize a lower grit for subsequent honing processes. The abrasive element may be, but is not limited to, a band sander. The abrasive element is fixed some distance from the article so the distance between the abrasive element and the exterior surface of the article does not change. The abrasive element may be mounted on a platform. In some embodiments the abrasive element may be, but is not limited to, bolted to the platform, glued to the platform, welded to the platform, clamped to the platform, or taped to the platform. The abrasive element may be attached to a mechanical structure, itself mounted on the platform, capable of rotating the angle of the abrasive element with respect to the plane of the platform. With respect to the plane of the platform defined on an x-y plane, the abrasive element may be rotated about the x- , y- , and/or z-axis. By rotating the angle of the abrasive element, the honing system can maintain contact at the fixed distance from an article with a complex or irregular surface contour. For example, the angle of the abrasive element may be adjusted to follow the curve of a convex article surface, such that the abrasive element remains in contact with the article at the fixed distance. In some embodiments, the article is mounted on a base and similarly configured to rotate the article to maintain contact with the abrasive element.

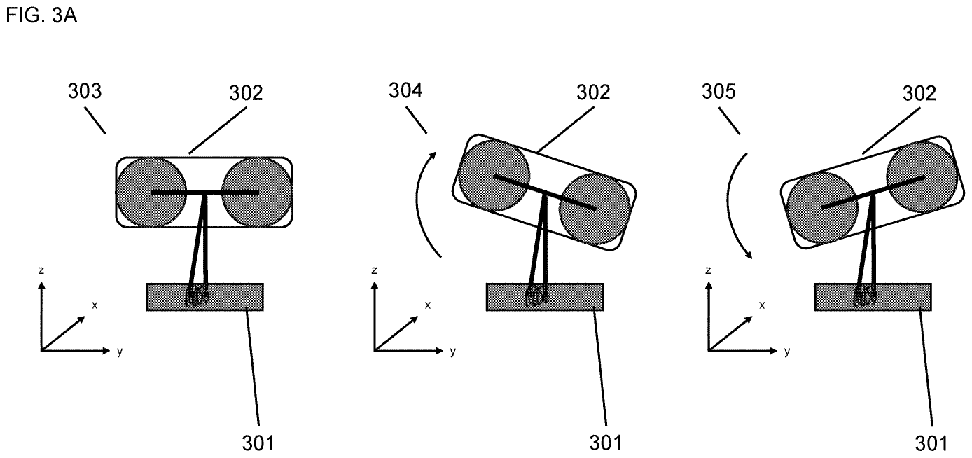

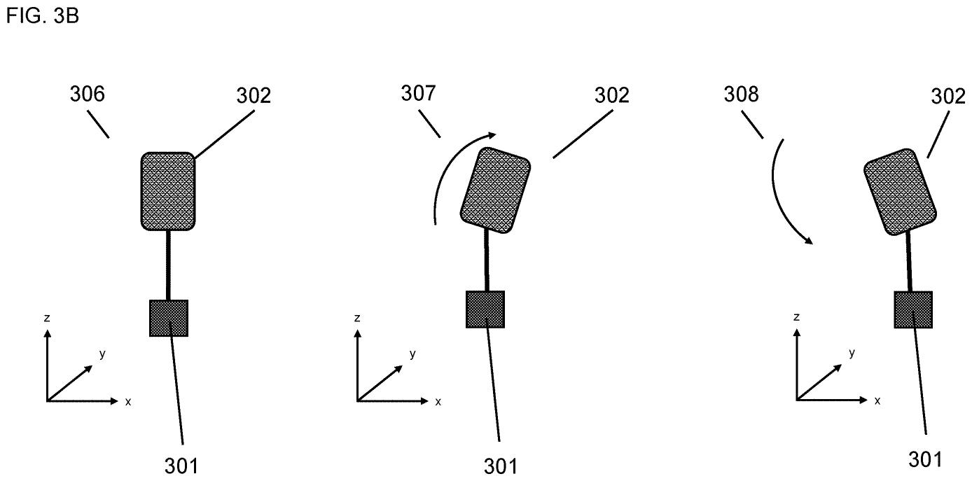

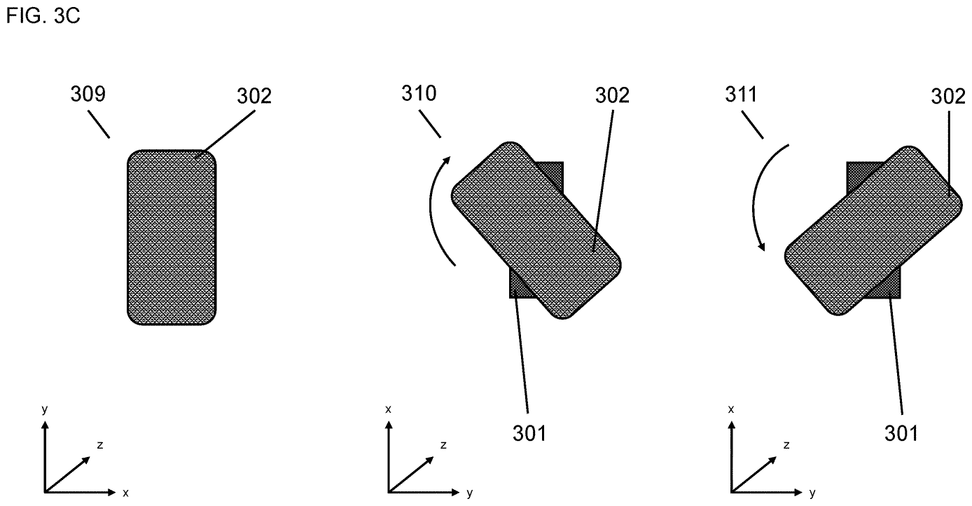

FIGS. 3A to 3C illustrate the rotation of the abrasive element with respect to the platform. The platform 301 remains fixed and the abrasive element 302 rotates about the x- , y- , and z-axis. The platform 301 defines an x-y plane with the abrasive element 302 above the x-y plane along the z-axis. FIG. 3A depicts the rotation of the abrasive element 302 about the x-axis. The abrasive element initially has no rotation 303. The abrasive element may be rotated in a first direction 304 and a second direction 304. FIG. 3B depicts the rotation of the abrasive element 302 about the y-axis. The abrasive element initially has no rotation 306. The abrasive element may be rotated in a first direction 307 and a second direction 308. FIG. 3C depicts the rotation of the abrasive element 302 about the z-axis. The abrasive element initially has no rotation 309. The abrasive element may be rotated in a first direction 310 and a second direction 311. Though FIGS. 3A to 3C depict the rotation of the abrasive element about one axis at a time, it should be understood the abrasive element may be rotated about one or more axis simultaneously.

In some embodiments, the platform may be configured to move about the article while maintain a fixed distance between the abrasive element and the external surface of the article. In some embodiments, the platform is configured to move along a length of the article in a horizontal and/or vertical direction. The platform may be attached to, including but not limited to rails, a track, a pully system, and/or a moveable cart. In some embodiments, the platform may be mounted on a track that matches the contours of an article. For example, given an article having a sinusoidal surface contour, a sinusoidal track that follows the contour of the article surface may be utilized. In several embodiments, the matched track may incorporate a cam driven truck. Furthermore, the matched track may minimize the independent rotation of the abrasive element to maintain contact with the exterior surface of the article. In several embodiments, the platform may be attached to an arm or another mechanical structure such that the abrasive element is capable of moving radially around the article. In many embodiments, the article is configured to rotate about its central axis. In some embodiments the platform is fixed. The article may be mounted on a base configured to move a length of the article along the abrasive element in a horizontal and/or vertical direction. The base may be configured on, including but not limited to, rails, a track, a pulley system, and/or a movable cart.

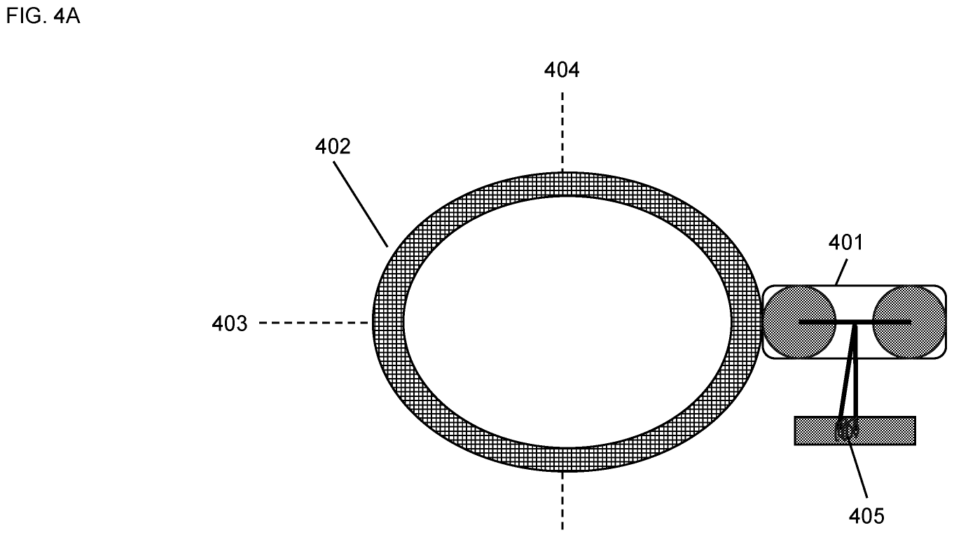

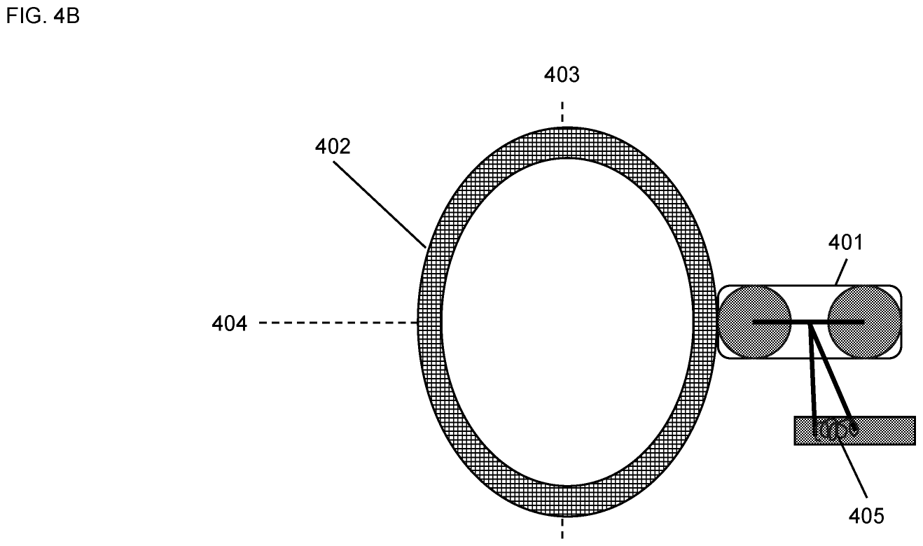

Honing techniques described herein maintain constant contact between the cutting or abrasive honing element and the external surface of the article through a force such that the honing element tracks the position of the external surface. The honing force applied removes an equal material thickness from the article surface regardless of variations in the article cross section diameter and/or shape along the length of the article. A honing force is maintained by adjusting the tension between the abrasive element and the platform. Adjusting the tension adjusts the amount of force applied to the article by the abrasive element. The tension adjusts to ensure a consistent honing force is applied to the article when the article cross section varies along the length of the article. The tension within the honing system may be determined based on the material of the article surface. In some embodiments, the honing force applied to the external surface of the article may be intentionally varied. Different surface materials may require a different honing force applied to achieve the desired finish. The intentionally varied honing force may be configured to achieve a varied finish on a single article. In some embodiments, the tension may be adjusted to achieve different desired finishes on the same or similar article material surface. In some embodiments, the honing force is constant. A constant honing force may be maintained by, but is not limited to, non-conventional springs, a motor, and/or pneumatics. In some embodiments, the honing system continually tracks the external surface of the article such that the tension on the honing element is adjusted to maintain constant force regardless of the changes in material and/or exterior cross section of the article. In some embodiments the honing force is relatively constant, such that there is a degree of variability in the honing force as the honing element moves with respect to the article. In some embodiments, the relatively constant honing force is maintained by a conventional spring. The honing system may comprise one or more springs to adjust the tension of the system. For example, in FIGS. 4A and 4B, a hollow article with an elliptical cross section will experience a consistent honing force but the tension within the system will be adjusted. The honing system will maintain a fixed distance between the abrasive element 401 and the external surface 402 of the article. FIG. 4A depicts when the long axis 403 of the article cross section is in contact with the abrasive element 401 the tension is increased by adjusting the load on the spring 405. FIG. 4B depicts when the short axis 404 of the article is in contact with the abrasive element 401 the spring is relaxed to maintain the honing force on the external surface 402 of the article when the contour has changed.

In some embodiments, the angle, the directional movement, and the tension of the honing system may be manually adjusted by a user. The user may use one or more levers or other controls to rotate the angle of the abrasive element around the x- , y- , and z-axis. The user may manually move the article in a direction along the abrasive element. The user may manually move the abrasive element along a length of the article. The user may utilize turn knobs to manually increase tension or decrease tension. In several embodiments, the angle of the abrasive element and/or article may be automatically adjusted. In many embodiments, the directional movement of the honing system may be automatically controlled.

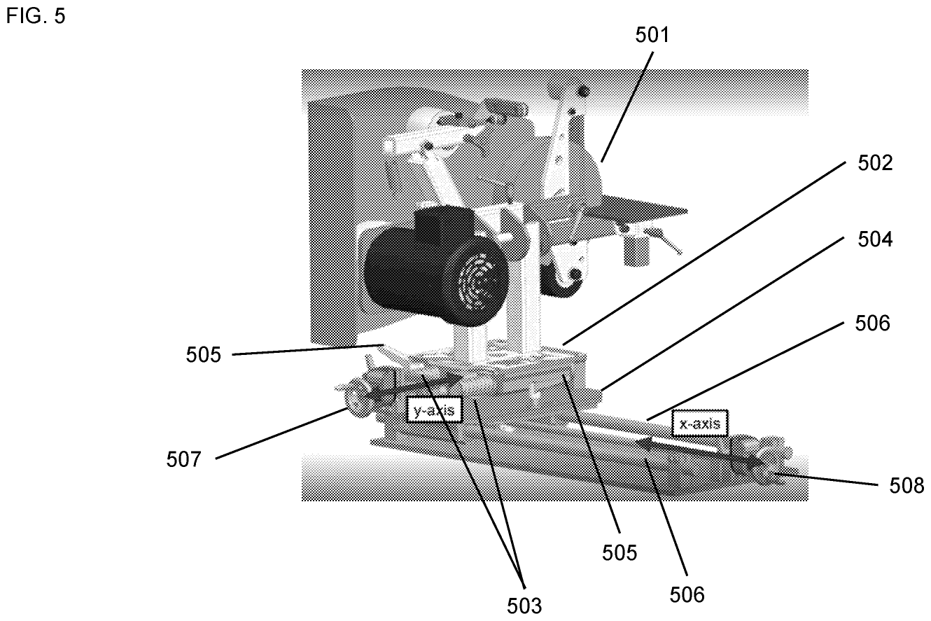

FIG. 5 depicts a schematic of the honing system capable of moving along rails while simultaneously adjusting the tension. The abrasive element 501 is mounted on a platform 502. The springs 503 attached to the platform 502 enable the tension of the honing system to be adjusted along the y-axis. The tension of the springs may be adjusted by the turn knob 507. The platform 502 is mounted on a secondary platform 504. Though the abrasive element is not shown to be rotated, it should be understood the levers 505 enable the rotation of the angle of the abrasive element along the x- , y- , and/or z-axis. The secondary platform 504 is further mounted on rails 506. The rails 506 allow the honing system to move linearly along the x-axis. The directional movement of the honing system along the rails may be controlled by the turn knob 508. It should be understood the levers 505 and/or turn knobs 507, 508 may be manually controlled or controlled automatically by a computer program.

In various embodiments the tension of the honing system may be automatically adjusted. In some embodiments, the tension of the honing system may be maintained by pneumatics capable of adjusting the pressure to maintain constant contact. The pneumatic motor may be configured to provide feedback on the operation of the system. The honing system may be configured to implement, including but not limited to, a computer program. The honing system may comprise a sensor to detect the contours of the external surface of the article during stops in the honing process and/or during the honing process. In some embodiments the sensor may be, but is not limited to, an infrared sensor, an imaging sensor, a three-dimensional scanner, photogrammetry, and/or any kind of one- , two- , or three-dimensional sensor. The honing system can follow the captured surface contours to automatically adjust the angle, directional movement, and/or tension of the honing system to provide consistent honing force and constant contact. The honing system may be configured to capture imaging data of the article as it hones an article. The honing system may be configured to capture image data of the article prior to honing. In some embodiments the honing system may acquire contour geometry data of an article without image sensing. The honing system may be loaded with a pre-created map of the article surface contour geometry by empirical measurement and/or from the CAD model. The honing system may be loaded with a pre-created map of the desired end-result surface contour geometry of a honed article. In some embodiments, the honing system is configured to automatically adjust the angle, directional movement, and tension of the honing system based on the parameters provided by the pre-created map. In some embodiments, the platform of the abrasive element is mounted on a robotic arm. The robotic arm may be configured to rotate the angle of the abrasive element in response to the programmed contour geometry data. In some embodiments, the base of the article may be mounted on a robotic arm such that the robotic arm adjusts the angle of the article based on programmed surface contour geometry data. In some embodiments the directional movement of the article and/or abrasive element may be controlled by a motorized cart. The motorized cart may be mounted on a track and/or rails. In some embodiments the motorized cart may be freely movable. In several embodiments, the motorized cart is configured to move the article and/or abrasive element based on programmed surface contour geometry data.

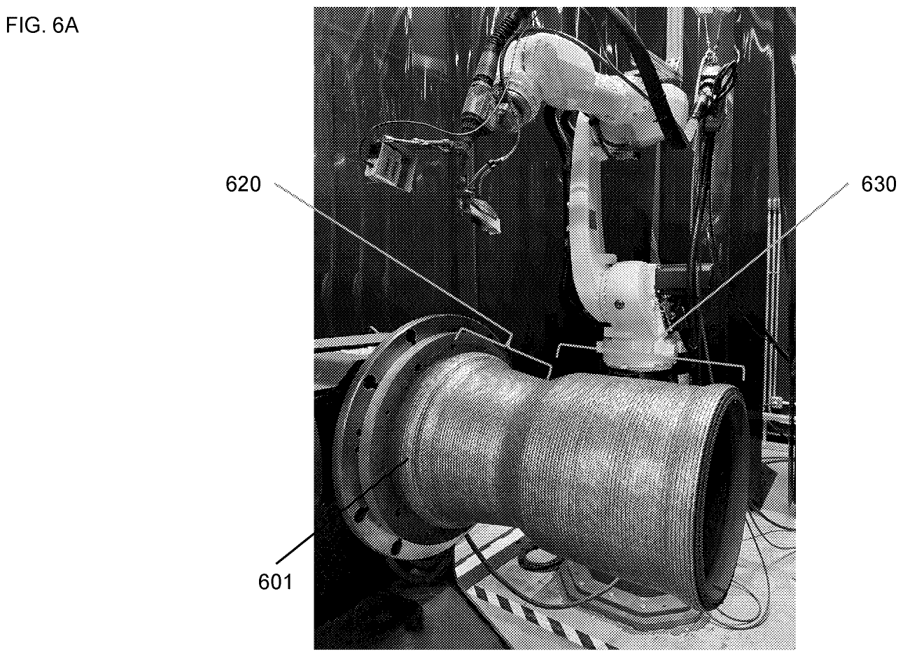

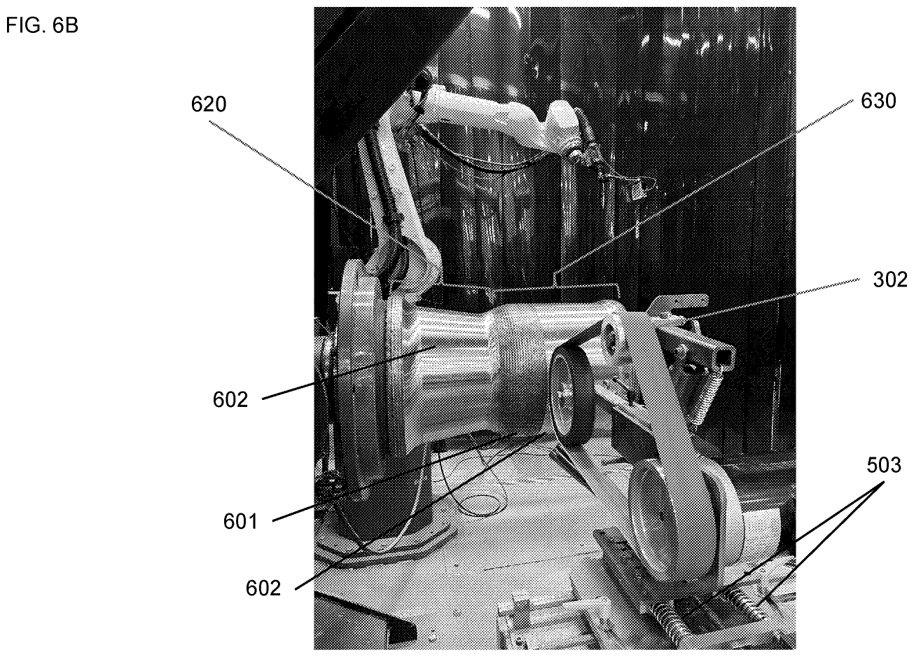

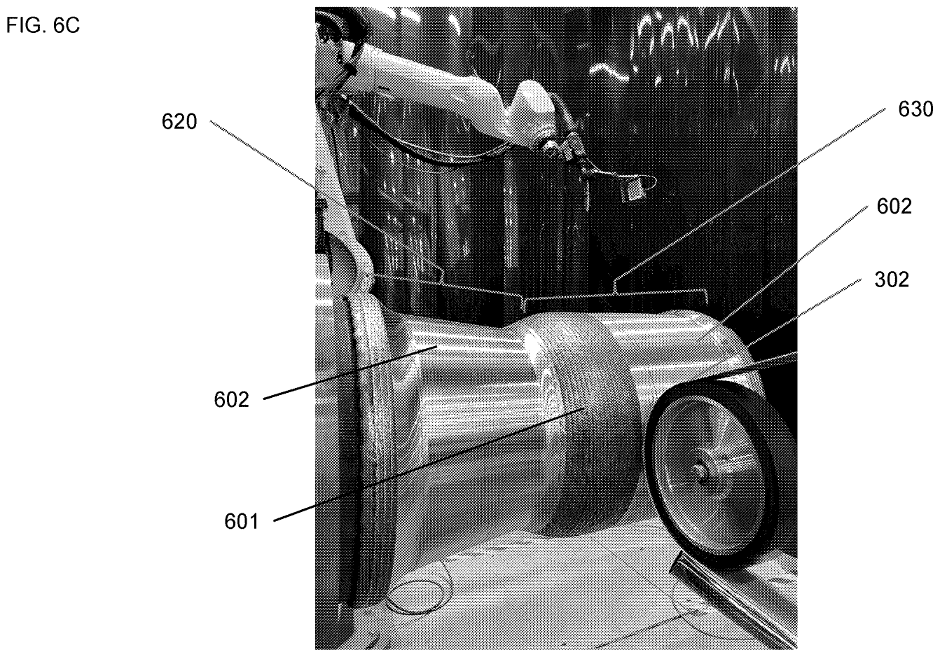

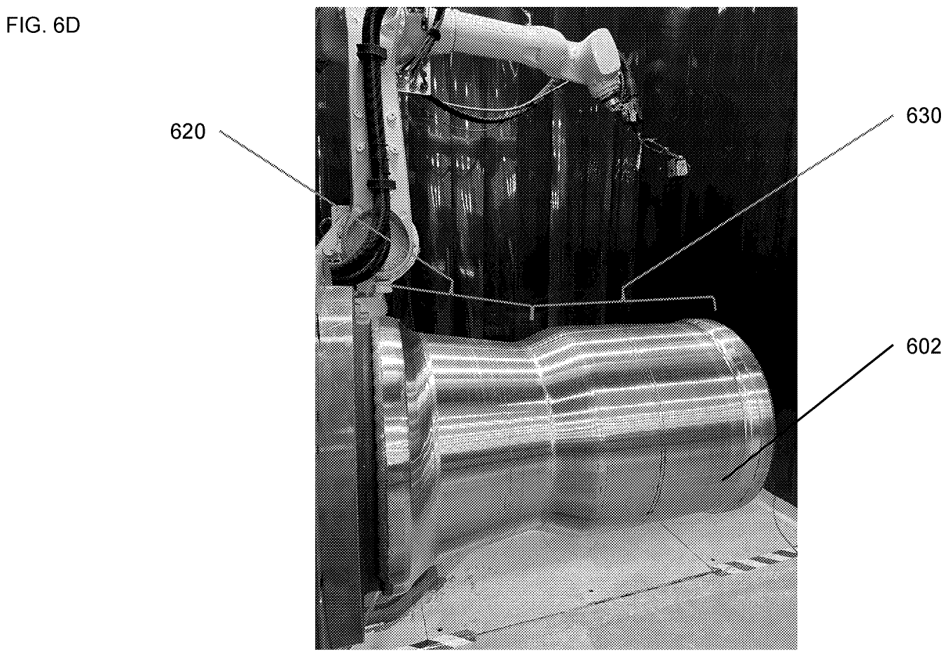

FIGS. 6A to 6D depict an article honed in accordance with various embodiments. The article in FIGS. 6A to 6D, a rocket engine thrust chamber assembly, was produced at least in part using wire arc additive manufacturing (WAAM) techniques (or different AM techniques) to create an outer cladding part to be honed, and at least in part using powder bed fusion (PBF) techniques (or different AM techniques) to create an inner liner part to be clad. Though an article manufactured with WAAM and PBF techniques is described in FIGS. 6A to 6D, it should be understood the systems and methods described herein can be applied to any article manufactured with any combination of AM techniques. In some embodiments, the cladding layer can be defined into different portions across the inner liner. For example, in FIGS. 6A to 6D the cladding layer of the article has a first portion 620 and a second portion 630. Though a first portion and a second portion 630 are identified in FIGS. 6A to 6D, it should be understood any number and/or configurations of portions can be identified depending on the desired application. The thicknesses of the first portion 620 and the second portion 630 can be different. In some embodiments, the thicknesses of the first portion 620 and the second portion 630 are the same. In various embodiments, the thickness of the each portion may comprise a plurality of thicknesses, such that the thickness within a portion varies. For example, the thickness of each portion can comprise one or more honed thicknesses and one or more un-honed thicknesses. In some embodiments, the plurality of portion thicknesses comprises one or more un-honed thicknesses and/or one or more honed thicknesses. FIG. 6A depicts the article prior to honing as described herein. In the example shown in FIG. 6A, the first portion 620 and the second portion 630 each comprise a plurality of thicknesses have an un-honed thickness. The article has a rough and irregular exterior surface 601. FIGS. 6B and 6C depict an article being honed by a honing system in accordance with an embodiment. As depicted in the example in FIGS. 6B and 6D, the first portion 620 and the second portion 630 each comprise a plurality of thicknesses having one or more honed thicknesses and one or more un-honed thicknesses. The plurality of thicknesses for each portion comprises one or more honed thicknesses and one or more un-honed thicknesses. The abrasive element 302 is in contact with the exterior surface of the article. As the abrasive element 302 makes contact with the bumpy exterior surface 601 a portion of the exterior surface material is removed resulting in a smoother exterior surface 602. The abrasive element 302 remains in contact with the exterior surface of the article through the tension maintained by the springs 503. FIG. 6D depicts an article with a smooth exterior surface 602 after being honed in accordance with various embodiments. In the example shown in FIG. 6D, the first portion 620 and the second portion 630 each comprise a plurality of thicknesses have a honed thickness. Though a rocket engine thrust chamber assembly is depicted in FIGS. 6A to 6D, it should be understood the systems and methods described herein can be applied to any type of article. Though an article with a first portion and second portion is depicted in FIGS. 6A to 6D, it should be understood the systems and methods described herein can be applied to any type of article having any combination and/or configuration of portions.

Articles honed as described herein are capable of aiding in article testing and regulation. Many article testing techniques require a smooth surface to operate various sensors to identify potential defects or confirm an article has met specification requirements. An article honed as described herein enables ultrasonic inspection (UT) of an AM article by reducing noise caused by rough and/or irregular exterior surfaces. An article honed as described herein enables higher resolution eddy current testing (ET) for surface inspection of AM articles.

Articles honed as described herein are also capable of receiving an additional layer of material deposited by, but not limited to, AM techniques such as WAAM. In many embodiments an article is honed to prepare the article for additional material layers. Honed articles have a smooth outer surface such that additional material layers can uniformly be deposited with an AM technique. In certain embodiments an article is additively manufactured, honed, and then additional material is deposited on the smooth outer surface. In certain embodiments the additional material deposited on the smooth outer surface has a higher strength, and/or other improved material characteristics, than it would have had it been deposited on the un-honed, rougher outer surface. The honed article can be initially manufactured to form an inner liner. The additional material deposited can form a cladding layer around the inner liner. In many embodiments the inner liner is manufactured with a first AM technique and the additional material is deposited according to a second AM technique. In certain embodiments, the first AM technique and the second AM technique are different. In some embodiments, the first AM technique and the second AM technique are the same. Any combination of AM techniques can be used for the first AM technique and the second AM technique. Articles produced by alternative techniques to AM may be honed as described herein, and further layered with additional material via AM techniques. For example, the initial layer may have been deposited by WAAM, PBF, another AM technique, or by another manufacturing process, then honed as described herein. Following processing by a honing system as described herein, the honed surface is capable of receiving additional material deposition by WAAM, PBF, another AM technique, or by another manufacturing process. In many embodiments the initial manufacturing technique may be different than a subsequent manufacturing technique applied to the honed article. For example, the article in FIGS. 6A to 6D, a rocket engine thrust chamber assembly, may have been produced at least in part using wire arc additive manufacturing (WAAM) techniques (or different AM techniques) and honing techniques to create an outer cladding part including a first layer of material, honed, upon which was received an additional layer of material.

### NDE Ultrasonic Testing

As described above, the un-honed region is ineligible for various non-destructive evaluation (NDE) testing techniques such as ultrasonic testing (UT) due to the increase noise scatter caused by the rough outer surface. Even for NDE inspection techniques that may tolerate the rough surface such as eddy current testing (ET), the required resolution of the inspection method is improved by honing the surface. The honed region 602 has a smooth outer surface. The honed region has been sanded to remove the excess rough and bumpy outer surface, the defects and spatter accumulated during a WAAM printing process, and some of the parasitic mass load on the article's surface. The honed region 602 has a sufficiently smooth surface to enable and enhance NDE testing by UT and ET. The honed region's 602 smooth surface enables the imaging sensor to be flush to the article material surface, and to enable the inspection by allowing the signal to noise ratio (reduction in surface based noise) to increase to sufficient levels.

Aspects of this disclosure are directed towards image sensing probes for NDE testing of honed articles. NDE testing, such as ultrasonic testing (UT), utilizes emitted signals to detect defects within an article or material. Traditionally, ultrasonic NDE imaging scans the volume of a weld to capture discrete defects. The ultrasonic sensor is affixed to the part via a rotating fixture that is wrapped around the circumferential article but the sensor may be handheld or affixed by other means. In some embodiments, the sensor may be affixed by a fixture, including but not limited to, clamp, cart, and/or chain. The sensor is scanned across the article by rotating the fixture around the circumference of the volume of weld metal.

In many articles produced by AM, the entire article can be likened to a continuous weld. Various embodiments are directed towards mounting the ultrasonic sensor to an extendable arm. In some embodiments, the extendable arm is mounted to a fixture that is wrapped around the circumference of the article. The sensor may be incrementally extended and/or retracted from the circumferential mounted fixture by the extension and/or retraction of the extendable arm, enabling scanning that is indexed against the other (‘height’) axis. In many embodiments, the sensor may be extended and/or retracted while the sensor is being rotated about the article. The dual motion of the sensor allows for NDE testing coverage of the entire surface area of the article. Through the attachment of the extendable arm, the rotating fixture does not need to be repeatedly removed to collect image data incrementally along the article.

In many embodiments, the rotation of the fixture may be manually controlled by a user. In several embodiments, the extension and retraction of the sensor may be manually controlled by the user. In various embodiments, the user can manually control the motion of the fixture and the extendable arm simultaneously. In some embodiments, the fixture may be wrapped around the circumference of an article. In several embodiments, the fixture may be, but is not limited to, a cart or a chain.

Several embodiments are directed to automatic NDE systems. In various embodiments, the speed and direction of the fixture can be controlled by a computer program. In many embodiments, the speed, direction, and distance of the extension and/or retraction of the extendable arm is controlled by the computer program. The computer program may be pre-programmed with the article's exterior geometry to determine the path of the NDE sensor. In some embodiments, the computer program may receive image data from the sensor to determine the article's exterior geometry to determine a path for the NDE sensor during the imaging process. In some embodiments, the computer program can alter the NDE sensor path based on the imaging data received. If the sensor detects a potential defect or anomaly, the sensor is configured to hover or back track to capture the potential defect or anomaly in more detail.

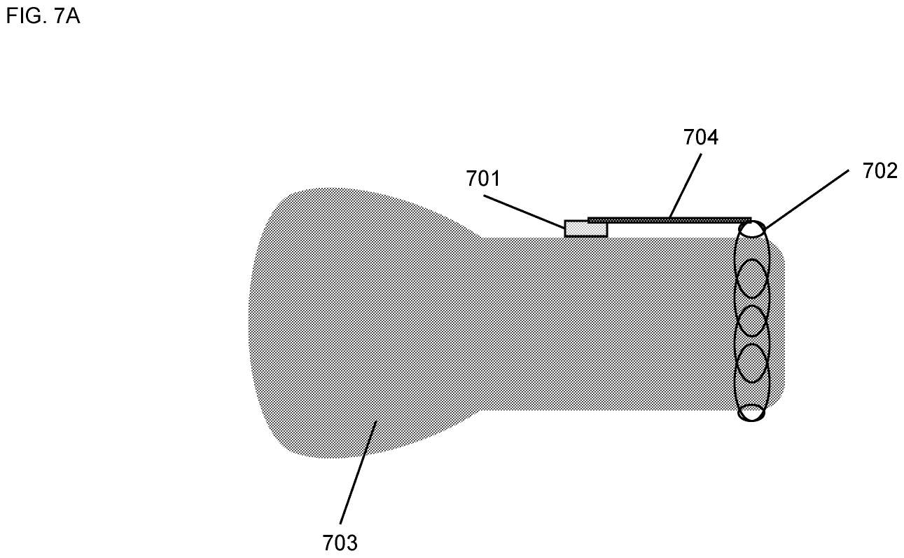

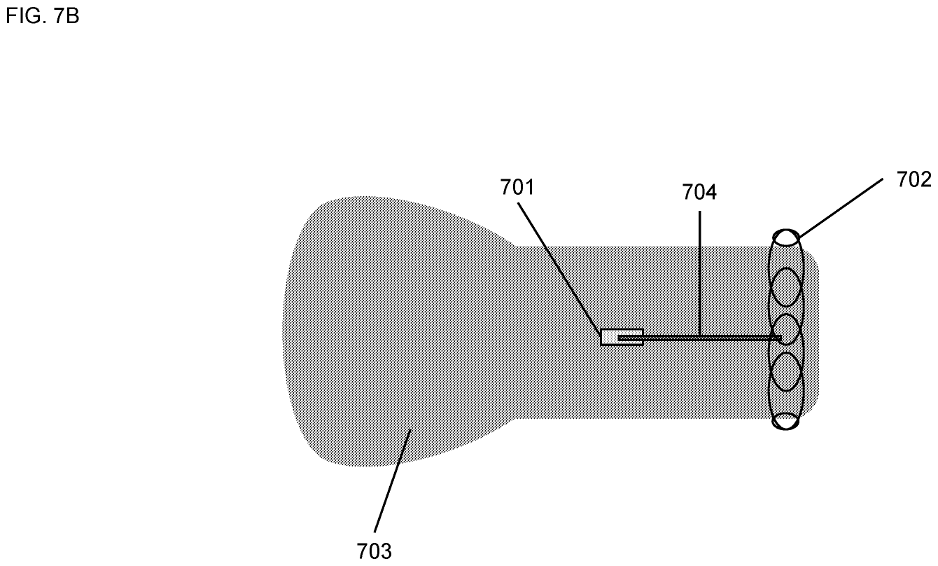

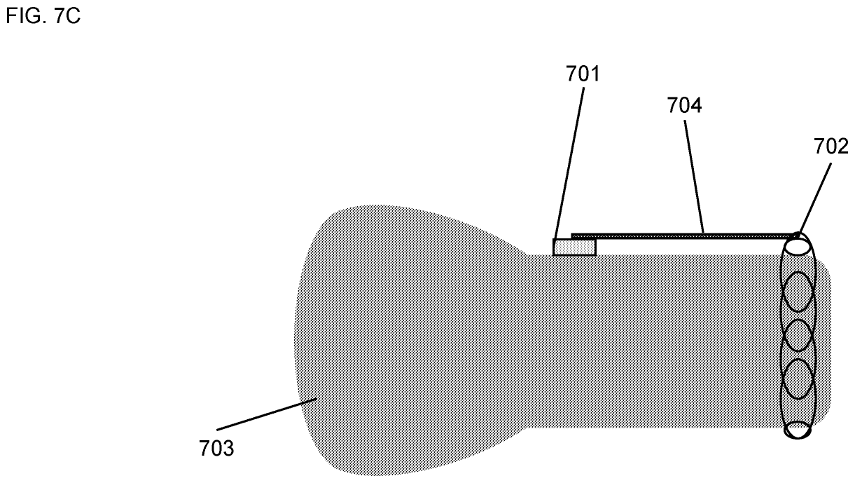

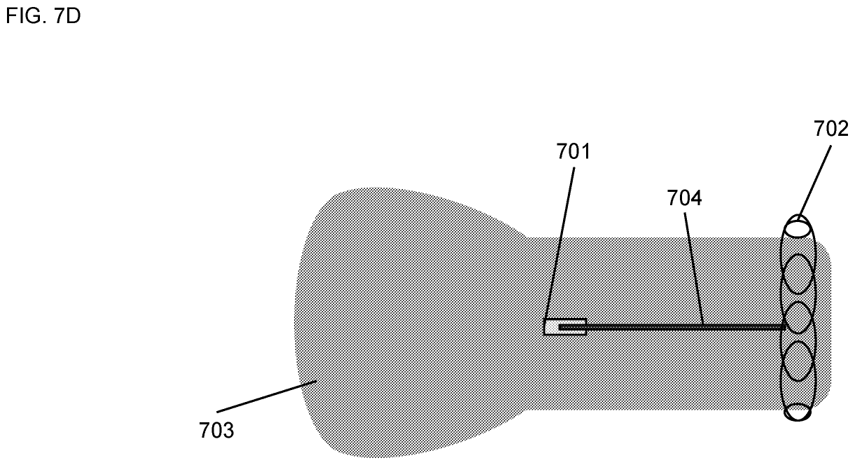

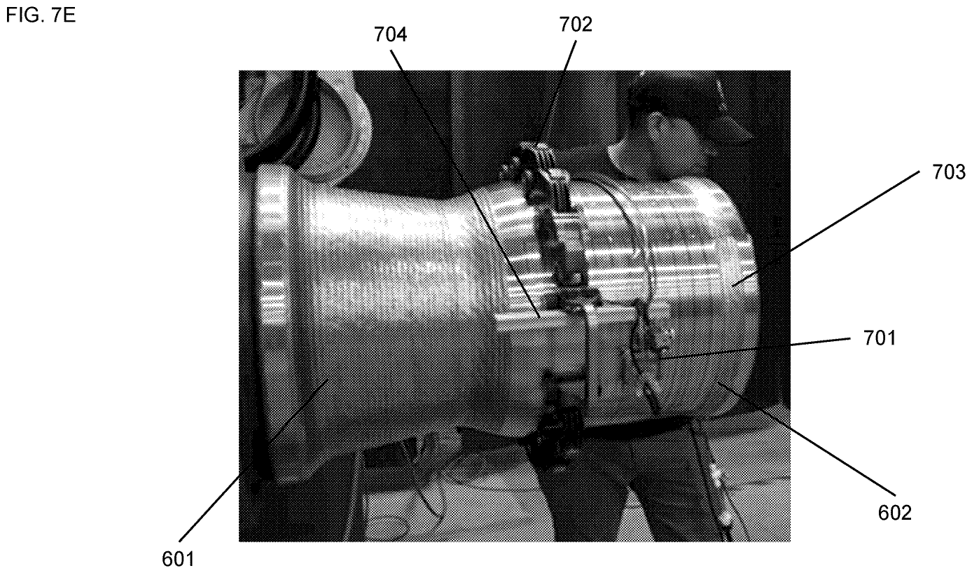

FIGS. 7A to 7D schematically illustrate NDE UT testing of a honed article 703 in accordance with an embodiment. The sensor 701 is attached to a first end of the extendable arm 704. The extendable arm 704 is capable of extending or retracting. FIGS. 7A and 7B depict the extendable arm 704 in a first retracted position. FIGS. 7C and 7C depict the extendable arm 704 in a second extended position. The second end of the extendable arm 704 is mounted on a fixture scanner 702. The fixture 702 is wrapped around the circumference of the article 703. The fixture 702 is configured to rotate about the article 703. FIGS. 7A and 7C depict the fixture 702 and attached sensor 701 in a first position. FIGS. 7B and 7D depict the sensor 701 in a second position due to the rotation of the fixture 702 about the article 703.

FIG. 7E provides an example embodiment of a NDE sensor system for AM article testing. The sensor 701 is mounted on a fixture 702. The fixture 702 is wrapped around the circumference of the article 703 with a honed surface 602 as described herein. Mounted on the fixture 702 is an extendable arm 704. The sensor 705 is mounted on one end of the extendable arm 704 such that the extendable arm 704 may distance the sensor 705 from the fixture 702. Article 703, a rocket engine thrust chamber assembly, was produced at least in part using wire arc additive manufacturing (WAAM) techniques (or different AM techniques) to create an outer cladding part with honed surface 602 surrounding a combustion chamber region and with a rough and irregular surface surrounding a throat region, and at least in part using powder bed fusion (PBF) techniques (or different AM techniques) to create an inner liner part to be clad.

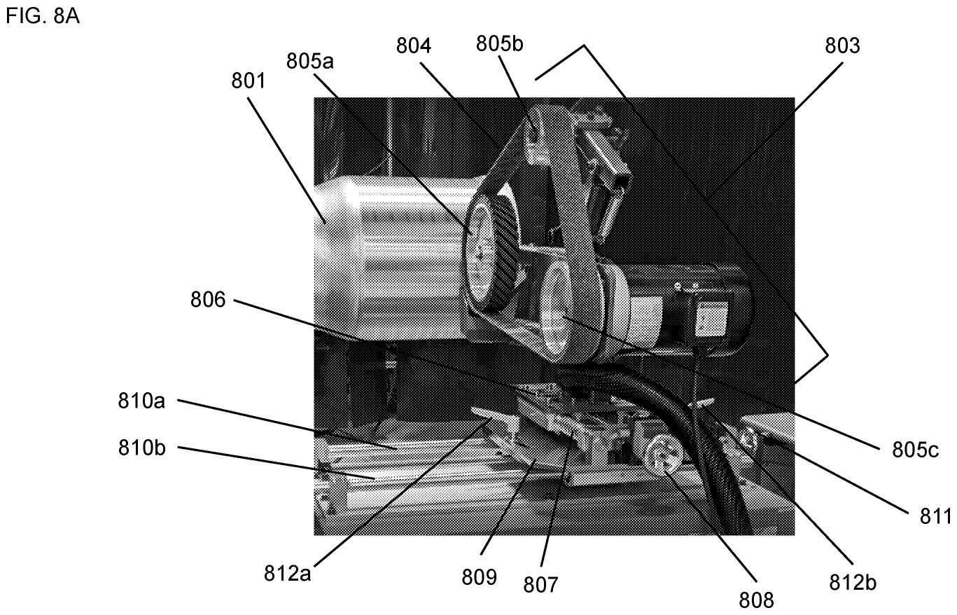

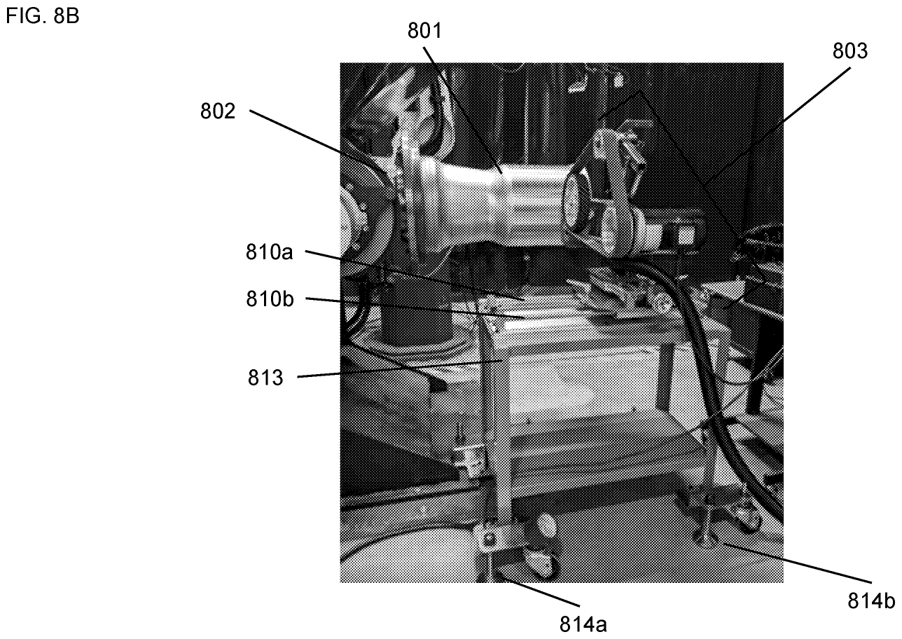

FIGS. 8A and 8B depict an example embodiment of a honing system configuration in accordance with an embodiment. FIG. 8A provides a detailed view of the abrasive element 803 utilizing sandpaper 804 to hone the article 801 surface. Article 801, a rocket engine thrust chamber assembly, was produced at least in part using powder bed fusion (PBF) techniques (or different AM techniques) to create an inner liner part to be clad. Though an article manufactured with WAAM and PBF techniques is described in FIGS. 8A and 8B, it should be understood the systems and methods described herein can be applied to any article manufactured with any combination of AM techniques. The belt sander is configured to rotate the sandpaper 804 around the wheels 805a, 805b, 805c. The speed of the sandpaper can be controlled by the belt sander motor. The belt sander is bolted onto a metal platform 806. In connection with the metal platform 806 is one or more springs 807 to control the tension within the honing system. The tension of the one or more springs 807 can be controlled by a user with a turn knob 808. The metal platform 806 is further mounted on a secondary metal platform 809. The secondary metal platform 809 is mounted on a set of rails 810a, 810b. The set of rails 810a, 810b allows the abrasive element 803 to move in a direction along the length of the article 801. The directional movement of the abrasive element 803 can be controlled by a user with a turn knob 811. The angle of the abrasive element 803 can be adjusted by the user using one or more levers 812a, 812b.

FIG. 8B depicts an entire honing system configuration in accordance with an embodiment. The article 801 is mounted on a robotic arm base 802. The robotic arm base 802 is configured to rotate the article 801 about its central axis. The abrasive element 803 and set of rails 810a, 810b are further mounted on a movable fixture 813. The movable fixture 813 is fixed to the floor to maintain the fixed distance during the honing process with retractable feet 814a, 814b.

### DOCTRINE OF EQUIVALENTS

This description of the invention has been presented for the purposes of illustration and description. It is not intended to be exhaustive or to limit the invention to the precise form described, and many modifications and variations are possible in light of the teaching above. The embodiments were chosen and described in order to best explain the principles of the invention and its practical applications. This description will enable others skilled in the art to best utilize and practice the invention in various embodiments and with various modifications as are suited to a particular use. The scope of the invention is defined by the following claims.

As used herein, the singular terms “a,” “an,” and “the,” may include plural referents unless the context clearly dictates otherwise. Reference to an object in the singular is not intended to mean “one and only one” unless explicitly so stated, but rather “one or more.”

As used herein, the terms “approximately” and “about” are used to describe and account for small variations. When used in conjunction with an event or circumstance, the terms can refer to instances in which the event or circumstance occurs precisely as well as instances in which the event or circumstance occurs to a close approximation. When used in conjunction with a numerical value, the terms can refer to a range of variation of less than or equal to ±10% of that numerical value, such as less than or equal to ±5%, less than or equal to ±4%, less than or equal to ±3%, less than or equal to ±2%, less than or equal to ±1 %, less than or equal to ±0.5%, less than or equal to ±0.1 %, or less than or equal to ±0.05%.

Additionally, amounts, ratios, and other numerical values may sometimes be presented herein in a range format. It is to be understood that such range format is used for convenience and brevity and should be understood flexibly to include numerical values explicitly specified as limits of a range, but also to include all individual numerical values or sub-ranges encompassed within that range as if each numerical value and sub-range is explicitly specified. Where ranges are described, the range should be understood to include the endpoints of the ranges, and the endpoints of such ranges are also contemplated to stand on their own as inventive, individual data points and to form the endpoints of other ranges. For example, a ratio in the range of about 1 to about 200 should be understood to include the explicitly recited limits of about 1 and about 200, but also to include individual ratios such as about 2, about 3, and about 4, sub-ranges such as about 1 to about 10, about 10 to about 50, about 20 to about 100, about 100 to about 200, and so forth, and related ranges such as greater than about 1 or less than about 200.

What is claimed is:

1. A method of producing an article, the method comprising:
creating a wall of the article, using a first additive manufacturing technique, defining an interior cavity and having a substantially uniform wall thickness and a nominally cylindrical geometry about a central longitudinal axis, wherein a cross-section of the wall taken perpendicular to the central longitudinal axis exhibits an elliptical profile;
reducing the substantially uniform wall thickness using a honing technique, wherein the reduced wall thickness remains substantially uniform;
creating a first portion of a cladding layer of the article, using a second additive manufacturing technique, covering a honed surface of the wall and having a substantially uniform first portion thickness and a nominally cylindrical geometry about the central longitudinal axis, wherein a cross-section of the first portion taken perpendicular to the central longitudinal axis exhibits an elliptical profile;
reducing the substantially uniform first portion thickness using the honing technique, wherein the reduced first portion thickness remains substantially uniform;
creating a second portion of the cladding layer of the article, using the second additive manufacturing technique, covering a honed surface of the first portion and having a substantially uniform second portion thickness and a nominally cylindrical geometry about the central longitudinal axis, wherein a cross-section of the second portion taken perpendicular to the central longitudinal axis exhibits an elliptical profile;
reducing the substantially uniform second portion thickness, using the honing technique, along a first extent of the central longitudinal axis, wherein the reduced second portion thickness remains substantially uniform along the first extent, and such that the second portion includes a honed surface of the second portion along the first extent and an un-honed surface of the second portion along a second extent of the central longitudinal axis.

2. The method of claim 1, wherein the article is a rocket engine thrust chamber assembly.

3. The method of claim 1, wherein the first additive manufacturing technique is a powder bed fusion technique.

4. The method of claim 1, wherein the second additive manufacturing technique is a wire arc additive manufacturing technique.

5. The method of claim 1, wherein the honing technique comprises:
applying an abrasive element to a surface of the article, wherein the abrasive element and the surface are at a honing distance, wherein the honing distance is substantially constant; and
moving at least one of the abrasive element and the surface such that the abrasive element removes material from the surface, wherein moving at least one of the abrasive element and the surface maintains the substantially constant honing distance between the abrasive element and the surface.

6. The method of claim 1, wherein the honing technique comprises:
applying an abrasive element to a surface of the article, wherein the abrasive element applies a honing force to the surface, wherein the honing force is substantially constant; and
moving at least one of the abrasive element and the surface such that the abrasive element removes material from the surface, wherein moving at least one of the abrasive element and the surface maintains the substantially constant honing force applied by the abrasive element to the surface.

7. The method of claim 5, wherein the surface is on at least one of the wall, the first portion of the cladding layer, and the second portion of the cladding layer.

8. The method of claim 5, wherein the honing distance is maintained by a tension system.

9. The method of claim 6, wherein the force is maintained by a tension system.

10. The method of claim 1, further comprising moving a non-destructive evaluation sensor along at least one of a honed surface of the wall, the honed surface of the first portion of the cladding layer, and the honed surface of the second portion of the cladding layer.

11. The method of claim 10, wherein the non-destructive evaluation sensor is an ultrasonic sensor.

12. The method of claim 1, wherein the elliptical profile results from a manufacturing deviation from circular symmetry.

13. A method of producing an article, the method comprising:
creating a wall of the article, using a first additive manufacturing technique, defining an interior cavity and having a substantially uniform wall thickness and a nominally cylindrical geometry about a central longitudinal axis, wherein a cross-section of the wall taken perpendicular to the axis exhibits an elliptical profile;
reducing the substantially uniform wall thickness using a honing technique, wherein the reduced wall thickness remains substantially uniform;
creating a cladding layer of the article, using a second additive manufacturing technique, covering a honed surface of the wall and having a substantially uniform cladding layer thickness and a nominally cylindrical geometry about the central longitudinal axis, wherein a cross-section of the cladding layer taken perpendicular to the axis exhibits an elliptical profile; and
reducing the substantially uniform cladding layer thickness using a honing technique, wherein the reduced cladding layer thickness remains substantially uniform.

14. The method of claim 13, wherein the creating the cladding layer of the article includes:
creating a first portion of the cladding layer of the article;
reducing a substantially uniform thickness of the first portion using a honing technique, wherein the reduced thickness of the first portion remains substantially uniform;
creating a second portion of the cladding layer of the article.

15. The method of claim 13, wherein the reducing the substantially uniform cladding layer thickness includes:
reducing the substantially uniform cladding layer thickness, using the honing technique, along a first extent of the central longitudinal axis, wherein the reduced cladding layer thickness remains substantially uniform along the first extent, and such that the cladding layer includes a honed surface of the cladding layer along the first extent and an un-honed surface of the cladding layer along a second extent of the central longitudinal axis.

16. The method of claim 13, wherein the article is a rocket engine thrust chamber assembly.

17. The method of claim 13, wherein the first additive manufacturing technique is a powder bed fusion technique.

18. The method of claim 13, wherein the second additive manufacturing technique is a wire arc additive manufacturing technique.

19. An article comprising:
a wall defining an interior cavity and having a substantially uniform wall thickness and a nominally cylindrical geometry about a central longitudinal axis, wherein a cross-section of the wall taken perpendicular to the axis exhibits an elliptical profile;
a first interface between a honed surface of the wall and an added surface of a first portion of a cladding layer;
the first portion of the cladding layer covering the honed surface of the wall and having a substantially uniform first portion thickness and a nominally cylindrical geometry about the central longitudinal axis, wherein a cross-section of the first portion taken perpendicular to the axis exhibits an elliptical profile;
a second interface between a honed surface of the first portion and an added surface of a second portion of the cladding layer;
the second portion of the cladding layer covering the honed surface of the first portion and having a plurality of second portion thicknesses and a nominally cylindrical geometry about the central longitudinal axis, wherein a cross-section of the second portion taken perpendicular to the axis exhibits an elliptical profile;
a honed surface of the second portion of the cladding layer extending along a first extent of the central longitudinal axis and having a honed thickness of the plurality of second portion thicknesses; and
an un-honed surface of the second portion of the cladding layer extending along a second extent of the central longitudinal axis and having an un-honed thickness of the plurality of second portion thicknesses.

20. The article of claim 19, wherein the article is a rocket engine thrust chamber assembly.
